(19) United States
(12) Patent Application Publication
(10) Pub. No.: US 2005/0126854 A1
(43) Pub. Date: Jun. 16, 2005

(54) Building-escaping system and method for making it

(76) Inventor: Qing-Hua Ye, Xiamen (CN)

Correspondence Address: IP MIDWAY INC., 1464 LARSEN CT, NAPERVILLE, IL, 60563, US

(21) Appl. No.: 10/734,901

(22) Filed: Dec. 15, 2003

(51) Int. Cl. A62B 1/06

(52) U.S. Cl. 182/73

(57) ABSTRACT

The current invention provides a safe and convenient escaping system in buildings to save life when catching fire and method for making it. The escaping system includes a released rope pulley and a lever on the outside wall of buildings, and can be hided in outside wall of buildings or hanging there. When fire takes place in the building, people trapped in will run to the position of escaping system, pulling the insured clasp of the free end of safe rope, hanging life belt or temporary one made of enough firm fabric on one's body on the clasp and sliding down safely. The invented escaping system can be used for all people including seniors, women, and children, because it slides down at a controlled safe speed.

### FIELD OF THE INVENTION

The present invention relates to a building safety product that helps people to escape from the building under emergency situations and a method for making it. More specifically, the present invention relates to a product pre-set in a building to help people to escape from the building when it catches fire or under other emergency situations and methods for making the escaping system.

### BACKGROUND

When fire takes place in buildings, elevators can't be used and the corridor and stairs are often full of smog, it is thus difficult for people to escape from the building under fire. Originally people use riveted ropes on the window or veranda in order to slide along the rope safely. However, for elderly people, pregnant women, and children, to slide down a hanging rope attached to a building is a danger way.

To avoid such dangerous escaping way, builders have used released rope pulley coiled round with the safe rope. Firstly, hanging life belt on the insured clasp, then wheeling the released rope pulley to release safe rope and making people slide down safely. Because of the acceleration of gravity, released rope pulley needs to be controlled by man so as to make people slide down at a lower and safe speed. However, without the help with others, it is hard for panicky people to use this device correctly.

Chinese patent ZL87201163 disclosed a safe drop device at high altitude. It proposes the safe drop device of high altitude, which is made up of a rope check coiled round with the safe rope, an insured clasp and slow sliding equipment. When fire takes place, firstly, to tie the belt of waist pack in the waist, hang the slow sliding equipment above the body of person, and hang the insured clasp on the object that can supports load. Then, people slide down from windows or veranda. In the slow sliding equipment, it consists of a released rope pulley and a coaxial rotational pulley, which together embed frictional clump outside. When people slide down, the safe rope that coils round the released rope pulley makes the released rope pulley and rotational pulley wheel. Under the function of centrifugal force, frictional clump rub against the inside face of slow sliding equipment to adjust the dropping speed at a steady rate. Here, people who is in panic need to find out the safe drop device at high altitude and put the rope check and slow sliding equipment of the safe drop device of high altitude on their bodies according to the demand, then use the insured clasp to make the free end of safety rope rivet the object which can receives load in the building. At last they may use the safe drop device of high altitude to flee for their lives. However, when people are in panic situation, they always react like a duck in a thunderstorm thus will be very hard to find out the dropping equipment and almost impossible to accomplish the preparative work described in the above technique.

Thus, there is a need for developing safer and easier ways of escaping from burning buildings and or under other emergency situations. Additionally, there remains a need for developing a system that elderly people, pregnant women, and children can use it under emergency situation such as firing in the building. More importantly, there remains a need for developing a convenient and yet effective method of escaping from a burning building. Most importantly, there remains a need for making such a device for people to escape from buildings under emergency situations such as firing.

### SUMMARY OF THE INVENTION

The object of the present invention is to eliminate the above-mentioned problems still associated with prior arts and to provide a safer and easier ways of escaping from buildings under emergency situations such as firing. According to the present invention, the escaping system uses ropes and relevant equipment to make people sliding from buildings to escape from emergent situations. The invention includes methods for making a system to escape from buildings under emergent situations, which includes a released rope pulley and a lever on the outside wall of buildings. When fire takes place, people who are trapped in run to the position of escaping system known beforehand, pulling the insured clasp of the free end of safe rope, hanging life belt or temporary one made of enough firm fabric on one's body on the clasp and sliding down.

In one aspect, the present invention is a method for people to escape from buildings under emergency situations such as fire. The escaping system includes pre-setting rope pulleys and lever on the outside wall of buildings, then to rivet the related pivot of lever into the outer wall, with one power point linking up with frictional clump withstanding released rope pulley outside and another point joining crown block where the free end of safe rope of released rope pulley is threaded through.

In one embodiment of this aspect of the invention, people who are trapped in buildings under emergency situations can easily pull the insured clasp of the free end of safe rope, hanging life belt on the clasp and sliding down from the outside wall. After lever receives strength, frictional clump rub with the outsides of released rope pulley so that people can slide down at a safe speed from buildings to escape.

The invention also includes methods for making a building escaping system that panic people can easily escape from a building under emergency situations. In one aspect, the current invention provides a method for making such a system and preset in the outside wall of buildings.

In one embodiment of this aspect of the invention, the escaping system includes pre-setting rope pulleys and lever on the outside wall of buildings, then to rivet the related pivot of lever into the outer wall, with one power point linking up with frictional clump withstanding released rope pulley outside and another point joining crown block where the free end of safe rope of released rope pulley is threaded through.

In another embodiment of this aspect of the invention, the shape of axial cross section of released rope pulley is ‘ [symbol] ’, and the point of the frictional clump has two filiations (each one sets a frictional clump and every frictional clumps peak to the outer circle of the released rope pulley).

In another aspect of the invention, the point of lever is a pair of axletrees. The rotational axis link up with the lever, and the axletree is riveted on the outside wall. In one embodiment of this aspect of the invention, the two points of lever lie in the both side of pivot. In another embodiment of this aspect of the invention, the two points of lever lie in the same side of pivot.

### BRIEF DESCRIPTION OF THE DRAWINGS

FIG. 1 is a diagram of the structure sketch of the invented escaping system for saving life when a building is under emergency situations.

FIG. 2 is a looking up structure sketch of example 1 of the invention.

FIG. 3 is a structure sketch of example 2 of the invention.

FIG. 4 is a structure sketch of example 3 of the invention.

FIG. 5 is a structure sketch of example 4 of the invention.

### DESCRIPTION OF THE PREFERRED EMBODIMENTS

The present invention is to provide a safe and easy way of escaping from buildings that under emergency situations such as firing. According to the present invention, the escaping system uses ropes and relevant equipment to make people sliding from buildings to escape from emergent situations. The method for making such a lifesaving escaping equipment includes a released rope pulley and a lever on the outside wall of buildings, from which people trapped in can run to the position of lifesaving equipment known beforehand, pulling the insured clasp of the free end of safe rope, hanging life belt or temporary one made of enough firm fabric on one's body on the clasp and sliding down to escape.

In one embodiment of this aspect of the invention, the building lifesaving escaping method includes a released rope pulleys and a lever on the outside wall of buildings. In another embodiment of this aspect of the invention, the escaping system utilizes the principle that levers control pressure produced from frictional clump withstanding the outside of released rope pulley and don't need other person's help.

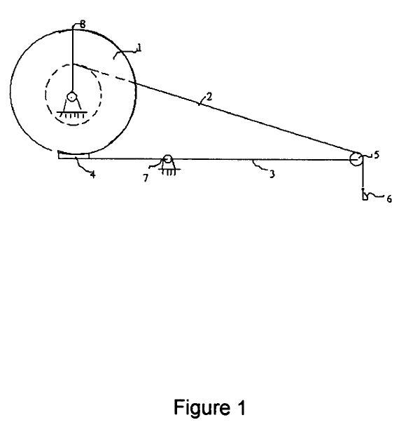

The aspect of the present invention typically includes a released rope pulleys and a lever as shown in FIG. 1. In one embodiment of this aspect of the invention, the main components of this escaping system are a released rope pulley 1 which contains safe rope 2 and a pair of lever 3. The rotational axis of released rope pulley 1 is riveted on the outer wall of the building by axletree 8. The pivot of lever 3 is a pair of axletree 7 whose rotational axis is linked with lever 3 and the axletree is riveted on the outer wall. The two power point of lever 3 places in the two sides of the pivot. Frictional clump 4 which lies in the power point of lever 3's short arm namely end 31 peaks up to the outer circle of released rope pulley 1 and crown block 5 which lies in the power point of long arm namely 32 hangs over the outer wall. The free end of safe rope 2 on the released rope pulley 1 contains an insured clasp 6 drills through crown block 5.

In one embodiment of this aspect of the invention, the escaping system shown in FIG. 1 can easily be operated by pulling the insured clasp 6 of safe rope 2's free end, hang the lifesaving belt on the insured clasp 6, and sliding down from the outer wall. Because of gravitation, the crown block 5 which is a power point of lever 3 turning down by passing the pivot and another power point namely frictional clump 4 being gored up and rubbed against the released rope pulley 1, from which the speed of releasing rope with released rope pulley 2 is limited so that the person can dropping down safely following the rope. In entire dropping process, no other people's help is needed so that each individual can escape in his/her own way.

In another embodiment of this aspect of the invention, the escaping system's Crown-block 5 of lever 3 shown in FIG. 1 only orients safety rope 2 that has been released, so it can be instead of oriented fork or oriented loop which was riveted on lever 3, but it will wear and tear safety rope 2 to do so. When safety rope 2 coils around the released rope ring, we should coil along the axes line. As a result, when it is released, safety rope 2 won't be parallel with lever 3 all the time. In order to prevent safety rope 2 breaking away from crown block 5, an oriented fork or oriented loop safety rope 2 is placed between released rope ring 2 and safety rope 2. This will make safety rope 2 parallel with crown block 5 when the rope arrive at crown block 5 through oriented fork or oriented loop and never fall apart from crown block 5.

The following examples describe and illustrate the methods and compositions of the invention. These examples are intended to be merely illustrative of the present invention, and not limiting thereof in either scope or spirit. Those skilled in the art will readily understand that variations of the materials, conditions, and processes described in these examples can be used.

### EXAMPLE 1

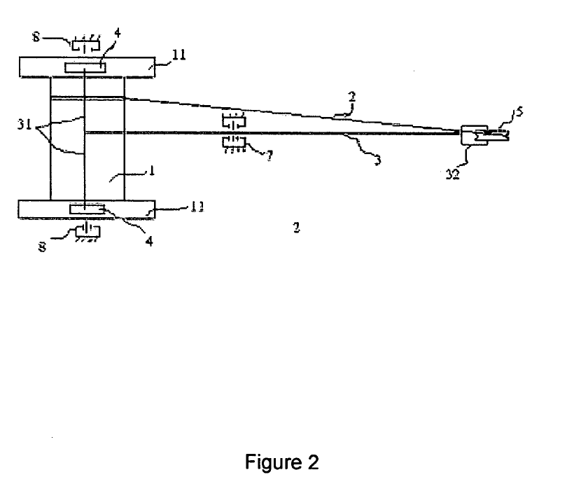

Make an axial cross-section of released rope pulley in ‘ [symbol] ’ shape as shown in FIG. 2. At the end of the lever 3's short arm, to rivet a rail 31 which branches two sides. In every branch, to set a frictional clump 4 that peaks up to the outer circle 11 of released rope pulley 1. By all appearance, when the frictional clump bears the same pressure, the longer the diameter of the released rope pulley 1's outer circle 11 is, the bigger the moment of frictional resistance will be, so the released rope pulley 1 slows down evidently. The heavier the person's avoirdupois is, the bigger the pressure of frictional clump 4 opposite lever 3 and the frictional resistance will be, so it can be used by different avoirdupois persons.

### EXAMPLE 2

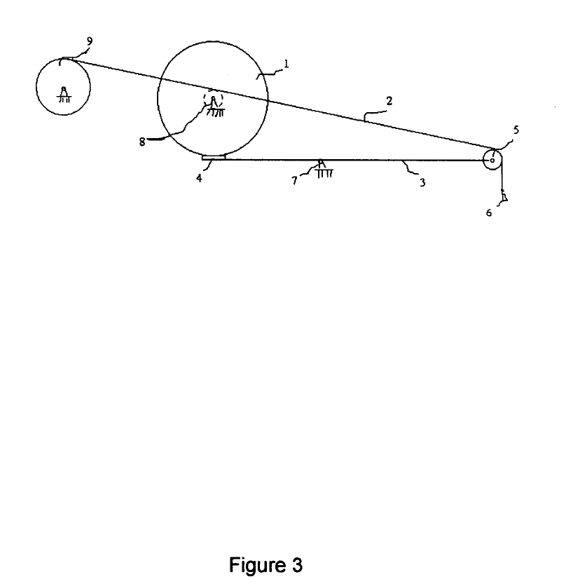

In addition to the basic components mentioned in the Example 1, add a rope check 9 to the escaping system as shown in FIG. 3. The rotational axis of rope check 9 is riveted on the outer wall of the building. Safety rope is mainly coiled round in the rope check 9 and the axis of released rope pulley 1 can be made thinker, which is only coiled around safety rope 2 with one or tow circles. Therefore, the speed of releasing rope and the frictional resistance in the place of the outer circle 11 of released rope pulley 1's two sides becomes proportional. When the frictional clump bear the same pressure, the quicker the rotate speed of released rope pulley is, the bigger frictional resistance the both side of outer circle of released rope pulley 1 will get, so that the released rope pulley 1 slows down evidently and the person can slide down at a spare speed safely.

### EXAMPLE 3

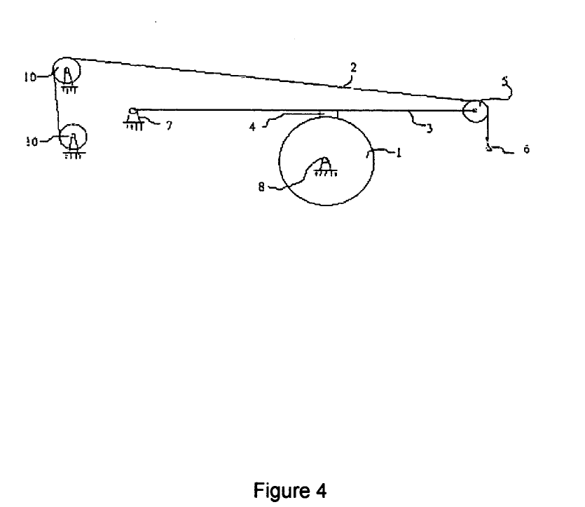

Made two power points on the lever 3 place in the same side of the pivot as shown in FIG. 4. At one end of lever 3 there is a pair of axletree 7 as a pivot whose rotational axis links to the lever and axletree rivet in the outer wall, at the other end of lever 3 is the power point of the long arm where crown block 5 handing over the outer wall place. The power point of short arm of lever 3 lies in the middle of lever 3 where frictional clump 4 place. To rivet rotational axis of released rope pulley 1 on the building's outer wall with axletree 8 and place under the frictional dump 4. The frictional clump 4 props up to the outer circle of released rope pulley 1. To make the safety rope 2 of released rope pulley 1 round through the two oriented loops 10 riveted on the outer wall and pull from the downside of lever 3 to the upside of lever 3, then, to make free point of safety rope 2 thrill through crown block 5 and hand down the insured clasp 6 riveted in the end out of the wall.

The process of escaping is the same as the previous examples. With the help of gravitation, the crown block 5 which is a power point of lever 3 turns down by pass the pivot and another power point namely frictional clump 4 is gored down and rubbed against the released rope pulley 1 so that the speed of releasing rope with released rope pulley 2 is limited and the person slide down safely following the rope. When safety rope 2 coils around the released rope ring, we should coil along the axes line. As a result, when it is released, safety rope 2 won't be parallel with lever 3 all the time. In order to prevent safety rope 2 breaking away from crown block 5, an oriented fork or oriented loop safety rope 2 is placed between released rope ring 2 and safety rope 2. This will make safety rope 2 parallel with crown block 5 when the rope arrive at crown block 5 through oriented fork or oriented loop and never fall apart from crown block 5.

### EXAMPLE 4

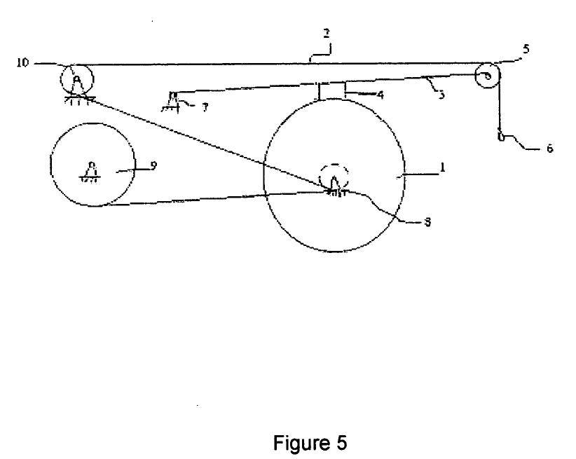

To the basic components mentioned in Example 3, add a rope check 9 as shown in FIG. 5 with rotational axis of rope check 9 on the building's outer wall with axletree. When situation occurs, coiling around safety rope 2 in the rope check 9 makes the axis of released rope pulley thin and coil around safety rope 2 released from rope check 9 with one or tow circles. When released by released rope pulley 1, safety rope 2 is rolled through the oriented loop 10 fixed on the wall and pulled from the downside of lever 3 to the upside, then to make the free point of safety rope 2 thrill through crown block 5. In this case, the rotation speed of released rope pulley 1 is proportional to the frictional moment out of the circle of released rope pulley 1. When the frictional clump bear the same pressure, if the rotate speed of released rope pulley augments, frictional resistance augments too but the speed of released rope pulley 1 will monishes, so the person can slide down at a safe and spare speed.

1. A lifesaving method to escape from buildings under emergency situations such as fire, which comprises:
A) Setting an escaping-system that includes rope pulleys and lever on the outside wall of buildings.
B) Rivet the pivot of lever on the outside wall, with one of its point linking up with frictional clump withstanding released rope pulley outside and another point joining crown block where the free end of safe rope of released rope pulley is threaded through, from which people who are trapped in the building can pull the insured clasp of the free end of safety rope, hanging life belt on the clasp and falling down from the outside wall to escape.

2. A method for making lifesaving system to escape from buildings under emergency situations, which comprises pre-setting a escaping-system that includes a released rope pulley and a lever that are riveted on the outside wall.

3. According to the claim 1, the characteristic of this escaping system is that after lever receives strength, frictional clump rub with the outsides of released rope pulley to make people sliding down at a controlled safe speed to escape from buildings under emergency situations such as fire.

4. According to the claim 1, this lifesaving escaping system can be pre-set in the wall of outside buildings and can easily be find and opened when needed.

5. According to the claim 2, the pivot of lever is riveted on the wall, with one of its point joining frictional clump withstanding released rope pulley outside and another point joining crown block where the free end of safety rope of released rope pulley is threaded through.

6. According to the claim 2, the characteristic of this lifesaving escaping system is that axial cross-section of released rope pulley is made as ‘ [symbol] ’ shape.

7. According to the claim 2, the characteristic of this lifesaving escaping system is that the point of the frictional clump has two filiations each with a frictional clump and every frictional clump peak to the outer circle of the released rope pulley.

8. According to the claim 2, the characteristic of this lifesaving escaping system is that the point of lever is a pair of axletree.

9. According to the claim 5, the characteristic of this lifesaving escaping system is that the point of the frictional clump has two filiations each with a frictional clump and every frictional clump peak to the outer circle of the released rope pulley.

10. According to the claim 6, the characteristic of this lifesaving escaping system is that the rotational axis link up with the lever and the axletree is riveted on the outside wall.

11. According to the claim 6, the characteristic of this lifesaving escaping system is that the two point of lever lie in the both side of pivot.

12. According to the claim 6, the characteristic of this lifesaving escaping system is that the two point of lever lie in the same side.

13. According to the claim 6, the characteristic of this lifesaving escaping system is that the two point of lever lie in the same side.

14. According to the claim 8, the characteristic of this lifesaving escaping system is that the rotational axis link up with the lever and the axletree is riveted on the outside wall.

15. According to the claim 8, the characteristic of this lifesaving escaping system is that the two point of lever lie in the both side of pivot.
